(19) United States
(12) Patent Application Publication
(10) Pub. No.: US 2002/0063928 A1
(43) Pub. Date: May 30, 2002

(54) FILTERING OF DATA-ENCODED OPTICAL SIGNALS

(76) Inventors: PER BANG HANSEN, BRADLEY BEACH, NJ (US); TORBEN N. NIELSEN, MONMOUTH BEACH, NJ (US)

Correspondence Address: JOHN A CACCURO, 9 LADWOOD DRIVE, HOLMDEL, NJ, 07733

(21) Appl. No.: 09/143,913

(22) Filed: Aug. 31, 1998

(51) Int. Cl. H04J 14/02; H04B 10/04; H04B 10/12

(52) U.S. Cl. 359/130; 359/188

(57) ABSTRACT

An optical filtering and multiplexing scheme obtains very high spectral density and increased maximum transmission distances without costly dispersion compensating equipment. The invention combines the filtering features of a multiplexing apparatus, such as a Waveguide Grating Router (WGR), to provide the bandwidth limitation necessary for maximizing the tolerance to dispersion. At the same time the WGR defines the bandwidth and center frequency spacing for the channels of the transmission system providing a robust interface which eliminates the possibility of non-compliant channels degrading the performance of the other channels.

### TECHNICAL FIELD OF THE INVENTION

This invention relates to the filtering of modulated optical signals and, more particularly, to a method of and apparatus for filtering data-encoded signals using an optical multiplexer.

### BACKGROUND OF THE INVENTION

A consequence of the proliferation of optical fiber amplifiers in commercial transmission system is that the transmission distance between regeneration typically is limited by dispersion. Dispersion compensating fibers or chirped fiber gratings are being investigated as means for overcoming the dispersion limit. However, implementing such compensation schemes will add significant cost and complexity to a system. Other methods for alleviating this problem include modulation schemes in which the signal occupies a smaller bandwidth and therefore can tolerate more dispersion.

What is needed is a simple and cost effective technique for limiting dispersion in optical transmission systems.

### SUMMARY OF THE INVENTION

Our invention is directed to a simple and cost effective method of and apparatus for limiting dispersion penalties in optical transmission systems. In accordance with our invention, an optical filtering and multiplexing scheme obtains very high spectral density and increased maximum transmission distances without costly dispersion compensating equipment. The invention utilizes the filtering features of a multiplexing apparatus, such as a Waveguide Grating Router (WGR), to provide the bandwidth limitation necessary for maximizing the tolerance to dispersion. At the same time, this apparatus defines the bandwidth and center frequency spacing for the channels of the transmission system providing a robust interface which eliminates the possibility of non-compliant channels degrading the performance of the other channels.

More particularly, our invention comprises a transmitter for modulating an optical signal with an electrical binary data signal at a predefined data rate. An optical waveguide router coupled to the transmitter optically filters the modulated optical signal, the router having a wavelength bandwidth which effectively cuts-off the frequency spectrum of the electrical data signal near the first null in its spectrum. The transmitter can be used with binary or duobinary type modulation signals or other modulation formats (e.g., quartinary).

In a Wavelength Division Multiplexed (WDM) embodiment, a plurality of transmitters each modulate a different optical signal with a different electrical data signal. A WGR router receives the modulated optical signal from each of the plurality of transmitters and optically filters these signals using an optical bandwidth in Hertz that is about the same as the data rate of the electrical data signal.

### BRIEF DESCRIPTION OF THE DRAWING

In the drawing,

FIG. 1 shows an illustrative block diagram of a prior art duobinary encoded transmitter;

FIG. 2 shows an illustrative block diagram of a prior art duobinary encoded transmitter including electrical filtering;

FIG. 3 shows an illustrative graph of the frequency response of a binary encoded signal;

FIG. 4 shows an illustrative graph of the frequency response of a duobinary encoded signal;

FIG. 5 shows an illustrative block diagram of a duobinary encoded transmitter in accordance with the present invention;

FIG. 6 shows an illustrative block diagram of a prior art binary encoded transmitter; and

FIG. 7 shows an illustrative prior art configuration of a Dragone waveguide grating router implemented in integrated optics.

### DETAILED DESCRIPTION

In the following description, each item or block of each figure has a reference designation associated therewith, the first number of which refers to the figure in which that item is first described (e.g., 101 is first described in FIG. 1).

Duobinary encoding has received much attention recently because of its higher spectral efficiency compared to conventional binary modulation. This higher spectral efficiency means that the duobinary format exhibits improved dispersion tolerance as well as allows for denser packing of channels in a wavelength division multiplexed transmission scheme. Furthermore, the duobinary signal format has no carrier which results in a higher threshold for stimulated Brillouin scattering, which increases with increases in the modulation rate.

Duobinary encoding employs three levels in the optical domain. One level for representing a binary “zero” is characterized by nominally zero optical intensity. The two remaining levels for representing a binary “one” exhibit the same optical power level, which is different from zero, and a relative phase difference of π. In a square-law detector two levels that have (identical) powers different from zero will result in the same electrical signal independent of the optical phases. They are therefore both mapped to the same data bit—typically the binary or logic “one”. In that case, the nominally zero intensity optical bit will then be mapped to the binary or logic “zero” data bit.

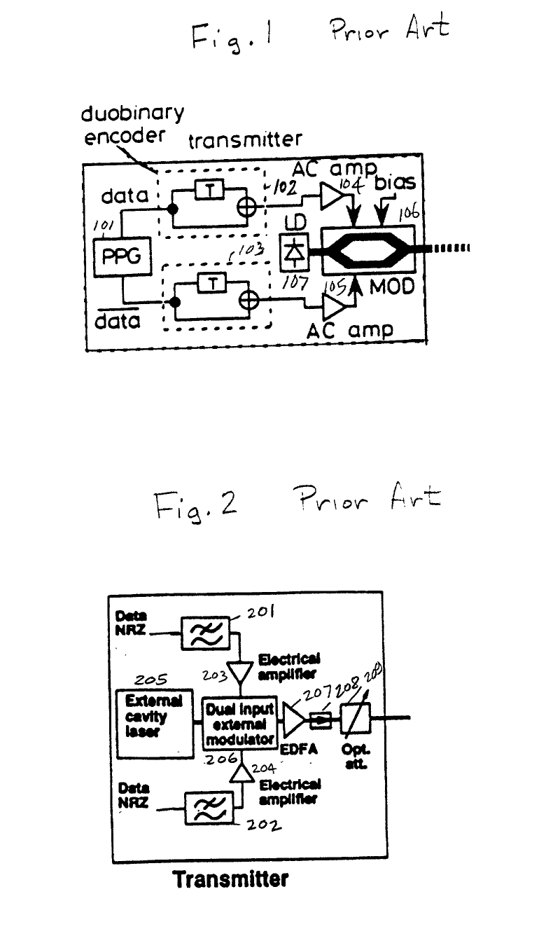

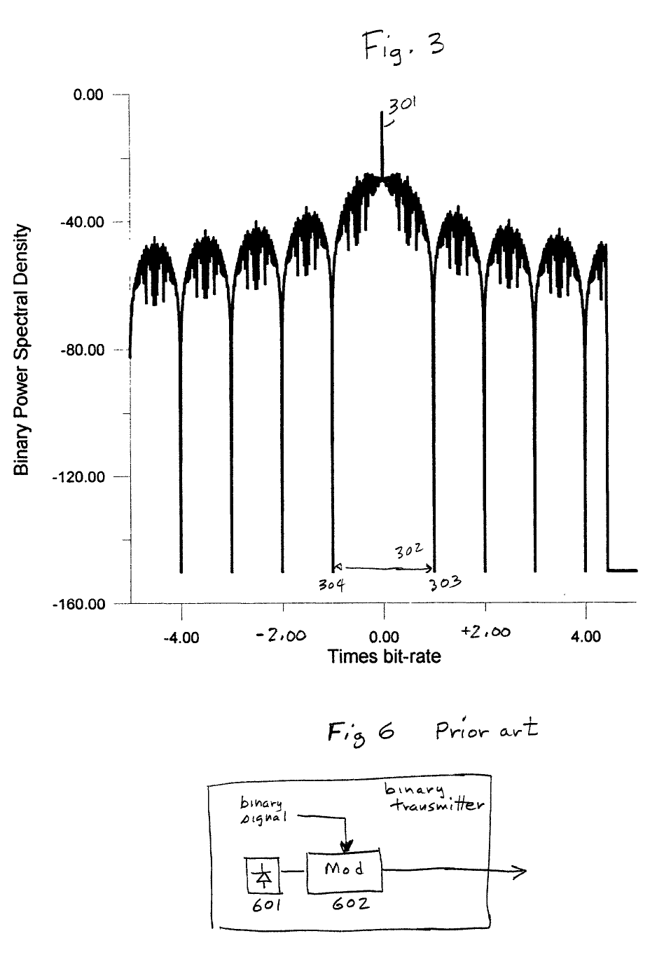

In terms of hardware implementation, duobinary encoding is attractive since receivers developed for binary modulation, which rely on square-law detection, are equally effective for the duobinary encoded signal format. Several implementations of transmitters have been demonstrated as shown in FIGS. 1 and 2.

Shown in FIG. 1 is an illustrative duobinary encoding transmitter as described in the article of K. Yonenaga, S. Kuwano, S. Norimatsu, and N. Shibata, “Optical duobinary transmission system with no receiver sensitivity degradation,” IEE Electronics Letters, Vol. 31, No. 4, pp. 302-304, 1995. With reference to FIG. 1, the Pulse Pattern Generator (PPG) 101 represents the binary data source. The data signal and the data NOT signal are applied to two duobinary encoders 102 and 103. The outputs of the duobinary encoders 102 and 103 are amplifier by amplifiers 104 and 105, respectively, and drive a Mach-Zehnder (MZ) modulator 106 which modulates the optical output of a Laser Diode (LD) 107.

The duobinary encoders 102 and 103 may, illustratively, be implemented in the manner disclosed in the pending patent application by P. B. Hansen and T. Franck, entitled “Duo-binary signal encoding,” Ser. No. ______, filed on Feb. 13, 1997, which is incorporated by reference herein.

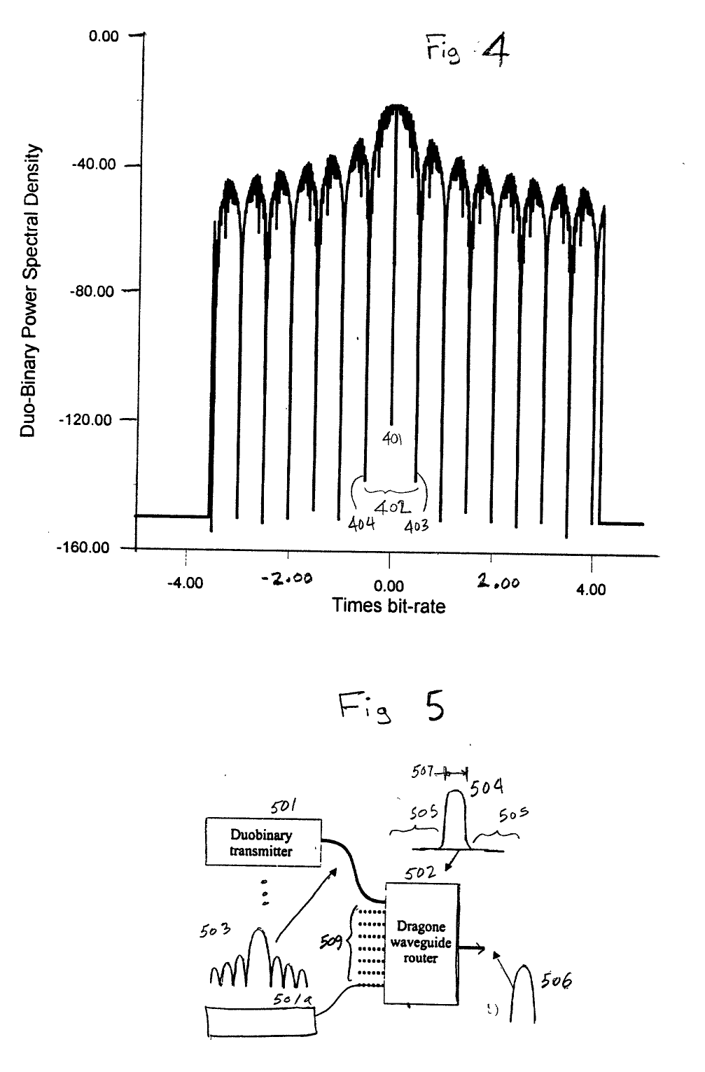

The power spectral density of the transmitter's output signal of FIG. 1, is shown in FIG. 4. As shown, the spectra has no carrier signal level 401 and an optical signal bandwidth 402 of one times the bit-rate; i.e., the base lobe that extends 0.5 times the bit-rate on either side of the carrier wavelength 401.

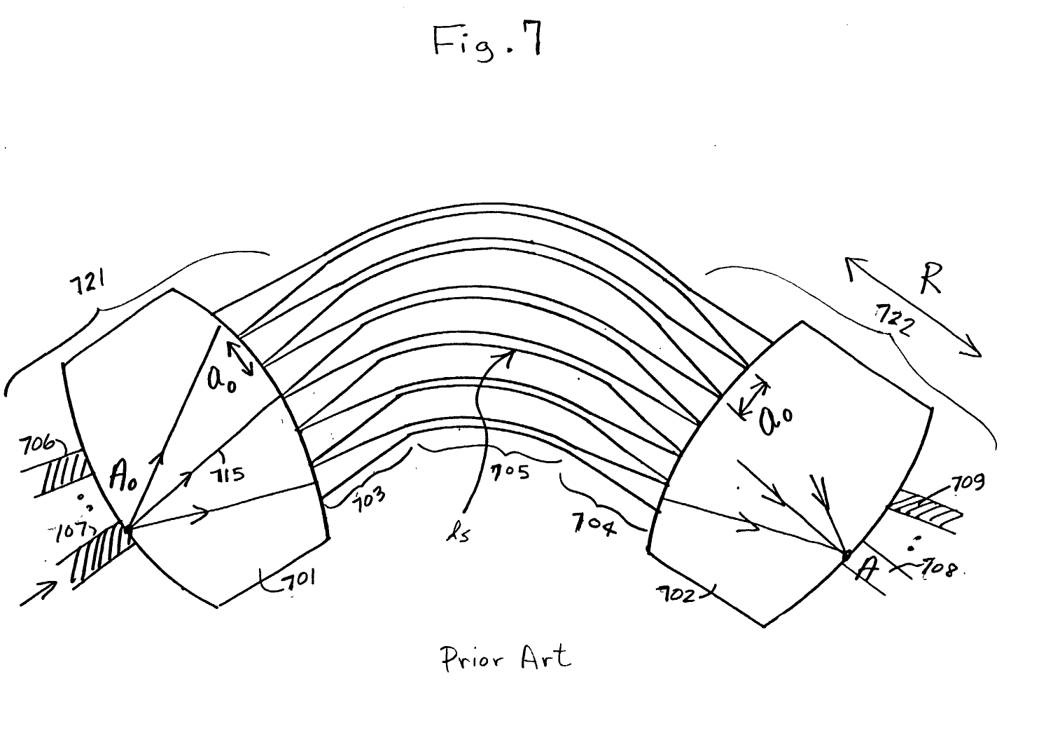

With reference to FIG. 3 there is shown the power spectral density of the output of a conventional binary transmitter of the type shown in FIG. 6. With brief reference to FIG. 6, there is shown an illustrative binary transmitter. The binary transmitter includes a light diode 601 which has its signal modulated in modulator 602 by a binary signal. Returning to FIG. 3, as expected, the output of a binary transmitter has a signal spectra including a carrier signal 301 (at the diode 601 signal wavelength) and bandwidth 302 of two times the bit-rate; i.e., the base lobe extends one times the bit-rate on either side (e.g., 303, 304) of the carrier wavelength 301.

A comparison of FIGS. 3 and 4 illustrates that the binary signal has a bandwidth that is twice that of the duobinary signal. This decreased bandwidth of the duobinary signal results in a decreased dispersion penalty or sensitivity and, as a result, an enhanced transmission distance between regeneration locations of an duobinary optical transmission system over that of a binary optical transmission system. The increased dispersion tolerance of the duobinary signal transmission depends on the signal components beyond the first null (e.g., 403) in the spectrum being insignificant. As noted with reference to FIG. 3, the first null in the electrical spectrum of a duobinary signal is at a frequency equal to half the bit rate—i.e. at 5 GHz for a 10-Gb/s signal.

Notwithstanding its dispersion improvement over the binary transmitter, the dispersion of the duobinary transmitter of FIG. 1 still, unfortunately, significantly limits the transmission distance between regeneration locations of an optical transmission system. In the prior art, electrical filtering techniques have been utilized to reduce the electrical signal bandwidth (i.e., to minimize the spectrum beyond the first null in the electrical spectrum ) and thereby improve the dispersion characteristics of the optical transmission systems.

Shown in FIG. 2 is an illustrative duobinary encoding transmitter including low-pass electrical filters for improving the dispersion-limited propagation characteristics. The operation of the circuit of FIG. 2 is described in the article of A. J. Price, L. Pierre, R. Uhel, and V. Havard, “210 km Repeaterless 10 Gb/s transmission experiment through nondispersion-shifted fiber using partial response scheme,” IEEE Photonics Technology Letters, Vol. 7, No. 10, pp. 1219-1221, 1995. With reference to FIG. 2, the respective data signals are filtered by low-pass filters 201 and 202, amplified in amplifiers 202 and 203, respectively, and modulate the laser carrier signal 205 in MZ modulator 206. The transmitter output level is set using amplifier 207, isolator 208 and adjustable attenuator 208.

Others have also proposed to reduce the modulating binary signal components beyond the first null in the spectrum by filtering of the signal before it is applied to the modulator. One such arrangement is described by S. Walklin and J. Conradi, in their article “On the relationship between chromatic dispersion and transmitter filter response in duobinary optical communication systems,” IEEE Photonics Technology Letters, Vol. 9, No. 7, pp. 1005-1007,1997.

We have recognized that the filtering can be performed on the modulated optical signal rather than on the electrical modulating signal. Moreover, since considerable fiber nonlinearities exist in the transmission fiber, the signal should be filtered electrically and/or optically before it is launched into the transmission fiber. Likewise, in a dense WDM system with channel spacings that approach the bit rate, the filtering should be applied before combining the channels.

In one embodiment, our invention is directed to the optical filtering of the modulated duobinary signals and in particular to filtering in the optical domain by an optical device which may simultaneously provide the wavelength aperture for the each of the channels being injected into a WDM transmission network. One such optical device, may be a “Dragone waveguide router” as described in U.S. Pat. No. 5,136,671, issued on Aug. 4, 1992 to C. Dragone and incorporated by reference herein. The Dragone router 502 defines the center wavelength and allocated bandwidth of each channel and therefore also the packing density in the wavelength domain.

In accordance with our invention, there is shown in FIG. 5 a schematic diagram of a duobinary transmitter 501 connected to a waveguide router 502 which provides the center wavelength and bandwidth allocation as well as the filtering necessary for ensuring the increased dispersion tolerance. The spectrum of the duobinary signal generated by the transmitter is shown by 503, the filter spectrum of the connected channel is shown as 504 and neighboring channels by 505, and the resulting spectrum is shown as 506, after filtering the signal 503 from transmitter 501.

Shown in FIG. 7 is an illustrative configuration of a Dragone Waveguide Grating Router (WGR) 502 implemented in integrated optics. Such a WGR is shown implemented by using a generalized Mach-Zehnder arrangement of many arms. This arrangement is generally symmetric, and comprises two dielectric planar slabs, 701 and 702, two periodic arrays, 703 and 704, and a set of waveguides (grating arms), 705, of different lengths, Iₛ, between the two arrays. Each of the input waveguides, 706-707, is connected to the first slab 701, and the input signal A₀ radiated from an input waveguide, e.g., 707, is transmitted to the periodic array 703 of receiving apertures, connected to the various arms 705. Each of the arms 705 has a length, Iₛ, that produces a suitable phase shift to its signal component, which is then radiated by the second array 704 into the second slab 702, and it is finally received by the output waveguides 708-709. The WGR of FIG. 7 is also referred to as including an input star coupler e.g., 721, a set of arms 705 and an output star coupler 722. In a well known manner, as described in the previously-identified patent, the number, spacings, dimensions, and arrangement of the star couplers 721 and 722 and set of arms 705 of the waveguide grating router of FIG. 7 can be designed to obtain the desired center wavelength and bandwidth characteristics necessary to obtain the required filtering needed for use in the arrangement of FIG. 5.

In accordance with the present invention, the bandwidth 507 of the connected channel 504, in Hertz, should be matched to the desired bit rate per channel so that the router 502 provides the filtering necessary for ensuring the decrease in dispersion of a duobinary encoded signal. Since the optical spectrum of the duobinary signal is double-sided 503, the router 504 should pass frequencies from the first null (404 of FIG. 4) below the center frequency (401 of FIG. 4) to the first null (403 of FIG. 4) above the center frequency. Thus, for example, if signal 503 is a 40 Gb/s duobinary signal it should be filtered by a router 504 having a bandwidth extending from 0.5 times the bit rate below the center (or carrier) wavelength (i.e., 404) to 0.5 times the bit rate above the center wavelength (i.e., 403). For our example, the bandwidth is 0.5+0.5 times the bit rate of 40 Gb/s, or a bandwidth of 40 GHz passband 402 extending from 20 GHz below to 20 GHZ above the center wavelength of the signal.

A channel will of course experience an increased power penalty as the modulated signal wavelength (signal channel) drifts away from the center wavelength allocated to that channel by the router 502. However, an important implication of this scheme is that as long as any wavelength drift or offset of the signal channel falls within its assigned router channel of router 502, the router 502 will prevent that signal channel from interfering with and degrading the performance of other signal channels in the system by preventing any power from being injected into the other signal channel bands.

Some additional improvement in the dispersion tolerance can also be obtained by electrically filtering conventional binary signal with a cut-off frequency near the first null in its spectrum. For a binary signal the first null appears at a frequency equal to the bit rate—i.e. at 10 GHz for a 10-Gb/s signal.

The proposed scheme of FIG. 5 can also be applied to a Wavelength Division Multiplexed (WDM) system carrying binary encoded channels (each of the channels would use a different binary transmitter 501-501a connected to a different input 509 of the router 502. It should be noted that the arrangement of FIG. 5, can be used with a transmitter that handles either binary or duobinary encoded signals. As the filter cut-off of router 502 should be nearly equal to the first null in the spectrum, the same router 502 would nominally accommodate duobinary channels with twice the data rate of the appropriate binary signal.

Thus, in accordance with the present invention, an optical filtering and multiplexing scheme is disclosed for use in an optical transmission system for simultaneously obtaining a very high spectral density in a Wavelength Division Multiplexed (WDM) system and increased maximum transmission distances without costly dispersion compensating equipment. The invention combines the filtering features of a multiplexing device, such as a waveguide grating router, to provide the bandwidth limitation necessary for maximizing the tolerance to dispersion. At the same time this embodiment defines the bandwidth and center frequency spacings for the channels of the transmission system providing a robust interface which eliminates the possibility of non-compliant channels degrading the performance of the other channels.

A non-compliant channel is a signal channels where the center wavelength is not accurate or which drift from their nominal values. While a Dragone type Waveguide Grating Router (WGR) has been described for use in our apparatus, it should be noted that other well known types of routers, such as routers based on interference filters, can be utilized. While the modulating data signals have been described as binary or duobinary signals having a prescribed bit rate, as previously noted, more generally, other types of data signals having prescribed symbol rates may be used in the invention. Thus, for example, quartinary data signals having a prescribed symbol rate may be used as the modulating signal.

What has been described is merely illustrative of the application of the principles of the present invention. Other arrangements and methods can be implemented by those skilled in the art without departing from the spirit and scope of the present invention.

What is claimed is:

1. An optical apparatus comprising
a transmitter for modulating an optical signal with an electrical data signal and
an optical waveguide router coupled to the transmitter for optically filtering the modulated optical signal, the router having a wavelength bandwidth which effectively cuts-off the frequency spectrum of the electrical data signal near the first null in its spectrum.

2. The optical apparatus of claim 1 wherein the router is a Waveguide Grating Router (WGR).

3. The optical apparatus of claim 1 arranged as a Wavelength Division Multiplexed (WDM) optical apparatus including
a plurality of said transmitters, each transmitter modulating a different optical signal with a different electrical data signal and wherein
said optical waveguide router is a WDM router having a plurality of inputs, each input being coupled to receive a different modulated optical signal from each of the plurality of transmitters, said WDM router using a different channel for optically filtering each of the received modulated optical signals, each channel having a different wavelength characteristic which optically filters an associated received modulated optical signal in a manner which effectively cuts-off the frequency spectrum of the electrical data signal used to modulate said associated received modulated optical signal near the first null in the frequency spectrum of that electrical data signal.

4. The optical apparatus of claim 1 wherein the transmitter is a duobinary transmitter.

5. The optical apparatus of claim 4 wherein the electrical data signal has a symbol rate of X symbols per second, where X is a number greater than zero, and wherein the frequency bandwidth of the optical waveguide router is X Hertz.

6. The optical apparatus of claim 1 wherein the transmitter is a binary transmitter

7. The optical apparatus of claim 1 wherein the electrical data signal has a symbol rate of X symbols per second, where X is a number greater than zero, and wherein the frequency bandwidth of the optical waveguide router is 2X Hertz.

7. An optical apparatus comprising
a transmitter for modulating an optical signal with an electrical duobinary data signal at a predefined symbol rate X and
an optical waveguide router coupled to the transmitter for optically filtering the modulated optical signal, the router having a wavelength bandwidth of about X Hertz.

8. A method of operating an optical apparatus comprising the steps of:
modulating an optical signal with an electrical data signal and
optically filtering the modulated optical signal with a bandpass filter having a wavelength bandwidth which effectively cuts-off the frequency spectrum of the electrical data signal near the first null in its spectrum.
